(19) United States
(12) Patent Application Publication
(10) Pub. No.: US 2022/0168947 A1
(43) Pub. Date: Jun. 2, 2022

(54) Thermally Conductive Thermoplastics for Fused Filament Fabrication

(71) Applicant: Eaton Intelligent Power Limited, Dublin (IE)

(72) Inventors: Shahab Zekriardehani, Farmington Hills, MI (US); Jeremy M. Santiago Baerga, Southfield, MI (US); Javed Abdurrazzaq Mapkar, Northville, MI (US)

(73) Assignee: Eaton Intelligent Power Limited, Dublin (IE)

(21) Appl. No.: 17/456,978

(22) Filed: Nov. 30, 2021

Related U.S. Application Data
(60) Provisional application No. 63/119,263, filed on Nov. 30, 2020.

(51) Int. Cl. B29C 64/118; C08K 3/04; B33Y 10/00; B33Y 70/00; B33Y 80/00; C08L 77/06; C08L 81/04

(52) U.S. Cl. CPC B29C 64/118; C08K 3/042; B33Y 10/00; B33Y 70/00; C08K 7/18; C08L 77/06; C08L 81/04; C08K 2201/001; B33Y 80/00

(57) ABSTRACT

The present disclosure relates to fused filament fabrication and thermally conductive polymers used therein. Also described are processes for forming an article using fused filament fabrication techniques.

### CROSS-REFERENCE TO RELATED APPLICATION

This application claims priority to U.S. Provisional Patent Application Ser. No. 63/119,263, filed Nov. 30, 2020, and which is hereby incorporated by reference in its entirety.

### STATEMENT REGARDING FEDERALLY SPONSORED RESEARCH OR DEVELOPMENT

This invention was made with government support under Government Contract DE-EE008722. The government has certain rights in the invention.

### FIELD OF THE DISCLOSURE

The present disclosure relates to fused filament fabrication and thermally conductive polymers used therein.

### BACKGROUND

Polymers are insulative materials in nature with a thermal conductivity of less than 0.5 W/m/K. One approach to increase the thermal conductivity is the inclusion of conductive fillers including carbon fiber, graphite, boron nitride, alumina, gold, copper, and graphene into the polymer matrix which, in some cases, can result in an increase of thermal conductivity up to 55 W/m/K. Usually, a high concentration of conductive fillers is required in order to significantly increase the base thermal conductivity of a polymer.

Fused filament fabrication (FFF) is a quickly growing 3D printing process, which has enabled industries to manufacture complicated geometries with various types of polymers. In particular, FFF is a 3D printing process that uses a continuous filament of a thermoplastic material to print an article. However, thermally conductive polymers have previously been unsuccessful in FFF processes. This is due, in part, to the high concentration of fillers in conventional thermally conductive polymers, increasing viscosity and thereby making the process itself harder and incapable of producing viable final product. The high concentration of fillers in conventional thermally conductive polymers also causes poor layer adhesion in the FFF process which compromises the printed article. Further, the presence of carbon fiber (typically used as a thermally conductive filler) in conventional thermally conductive polymers imparts poor surface quality onto the finished article.

The present disclosure seeks to address these challenges.

### SUMMARY OF THE DISCLOSURE

In one aspect, a process of forming an article generally comprises providing a thermally conductive polymer. The polymer comprises spherical nano-particles and is in the form of a filament. The process further comprising extruding the filament in a fused filament formation process to produce a 3D printed article comprising the thermally conductive polymer.

In another aspect, a process of forming an article generally comprises providing a thermally conductive polymer. The polymer is in the form of a filament and has a viscosity of less than about 1.0E+3 at 290° C. and 1 S⁻¹ shear rate. The process further comprises extruding the filament in a fused filament formation process to produce a 3D printed article comprising the thermally conductive polymer.

In yet another aspect, a thermally conductive polymer generally comprises a polymer matrix and spherical nano-particles in the polymer matrix. The thermally conductive polymer has a viscosity of less than about 1.0E+3 at 290° C. and 1 S⁻¹ shear rate configuring the polymer to have adequate layer adhesion and sufficient surface quality such that the polymer is suitable for fused filament fabrication.

### DETAILED DESCRIPTION

The present disclosure involves fused filament fabrication (FFF) printing techniques and specifically FFF processes using thermally conductive polymers. The FFF processes of the present disclosure utilize a continuous filament formed from a thermally conductive polymer. The filament is pushed through an extruder that prints the desired article. Thus, the final printed article comprises a thermally conductive polymer having adequate layer adhesion and sufficient surface quality. Therefore, the FFF process results in a viable final product formed from a thermally conductive polymer.

The thermally conductive polymer from which the filament used in the FFF process is produced comprises a polymer matrix. In particular, useful polymers include thermoplastic polymers, for example, acrylonitrile butadiene styrene, acrylic, celluloid, cellulose acetate, cyclic olefin copolymer, ethylene-vinyl acetate, ethylene vinyl alcohol, polytetrafluoro ethylene, ionomers, liquid crystal polymer, polyoxymethylene, polyacrylates, polyacrylonitrile, polyamide (e.g., polyamide 66 or polyamide 6), polyamide-imide, polyimide, polyaryletherketone, polybutadiene, polybutylene terephthalate, polycarpolactone, polychlorotrifluoroetyhlene, polyether ether ketone, polyethylene terephthalate, poly-cylcohexylene dimethylene terephthalate, polycarbonate, polyhydroxalkanoates, polyketones, polyester, polyolefin (e.g., polyethylene, polypropylene, polybutylene, and the like) polyetherketoneketone, polyetherimide, polyethersulfone, polysulfone, chlorinated polyethylene, polylactic acid, polymethylmetacrylate, polymethylpentene, polyphenylene, polyphenylene sulfide (PPS), polyphthalamide, polystyrene, polysulfone, polytrimethylene terephthalate, polyurethane, polyvinyl acetate, polyvinyl chloride, polyvinylidene chloride, styrene-acrylonitrile, or mixtures thereof. Polyamides and polyphenylene sulfides are particularly preferred.

The thermally conductive polymers used in the FFF processes described herein have reduced brittleness as compared to conventional thermoplastics used in FFF processes through the incorporation of spherical nano-particles. In one embodiment, there is a threefold improvement of the extruded filament brittleness by incorporating spherical nano-particles. The nano-particles can also help to lower the viscosity and to reinforce the nanocomposite. In one embodiment, the viscosity of the thermally conductive polymer is less than about 1.0E+3 at 290° C. and 1 S⁻¹ shear rate. However, this value may differ depending on the identity of the polymer matrix, as the skilled person will readily understand. The spherical nano-particles include, but are not limited to, nano-diamonds, fumed silica, nano-alumina, fumed alumina, or combinations thereof. The nano-particles can be included in the polymer matrix in concentrations of at least about 0.1 wt. %, at least about 0.5 wt. %, at least about 1 wt. %, at least about 1.5 wt. %, or at least about 2 wt. %. For example, the nano-particle concentration can be from about 0.1 wt. % to about 2 wt. %.

The thermally conductive polymers used in the present FFF process also typically have a cold crystallization onset of less than about 220° C., which allows for better layer adhesion and surface quality. The cold crystallization temperature can be less than about 210° C., less than about 200° C., less than about 190° C., less than about 180° C., less than about 170° C., less than about 160° C., less than about 150° C., less than about 140° C., less than about 130° C., less than about 120° C., less than about 110° C., or less than about 100° C.

The thermally conductive polymers used in the FFF process also have a reduced crystallinity in order to reduce warpage and distortion of the printed parts. For example, the crystallinity can be less than about 10%, less than about 9%, less than about 8%, less than about 7%, less than about 6%, less than about 5%, less than about 4%, or less than about 3%.

A thermally conductive filler used in the thermally conductive polymer in the FFF process can comprise any filler with thermal conductivity known in the art. The filler can have high thermal conductivity (for example, having a thermal conductivity of up to about 900 W/m/K or greater than about 10 W/m/K), an intermediate thermal conductivity (for example, having a thermal conductivity of from about 5 W/m/K to about 10 W/m/K), or a low thermal conductivity (less than about 5 W/m/K). Generally, high thermal conductivity and intermediate thermal conductivity fillers are preferred when used primarily as the thermally conductive filler.

As an example, the thermally conductive filler can comprise carbon black, alumina, boron nitride, silica, carbon fiber, graphene, graphene oxide, graphite (such as, for example, expanded graphite, synthesized graphite, low-temperature expanded graphite, and the like), aluminum nitride, silicon nitride, metal oxide (such as, for example, zinc oxide, magnesium oxide, beryllium oxide, titanium oxide, zirconium oxide, yttrium oxide, and the like), carbon nanotubes, calcium carbonate, talc, mica, wollastonite, clays (including exfoliated clays), metal powders (such as, for example, aluminum, copper, bronze, brass, and the like), or mixtures thereof.

The thermally conductive polymers described herein are designed specifically for processes of 3D printing, specifically for fused filament fabrication. That is, the thermally conductive polymers described herein can be extruded in 3D printers. Thus, provided herein is a process of forming an article comprising: providing a thermally conductive polymer in the form of a continuous filament; and extruding the thermally conductive polymer through a 3D printer. The thermally conductive polymer is typically extruded in layers whereby the printed article is formed from the bottom up. In particular, the fused filament process comprises feeding the filament of thermally conductive polymer material from a spool through a moving, heated printer extruder head, and depositing the material on a growing work. The printer head may be operatively connected to a controller that is programmed to print the desired shape for the thermally conductive polymer material. The printer head may move in two dimensions to deposit one horizontal plane, or layer, at a time. The print head can then be moved vertically by a small amount to begin a new layer.

The unique configuration of the thermally conductive polymer facilitates use of the polymer in the fused filament fabrication process. For example, the use of nano-particles in the thermally conductive polymer reduces the viscosity of the polymer and improves the layer adhesion of the printed layers thereby forming a viable printed article.

The thermally conductive polymers and processes described herein can be used to prepare articles known to those skilled in the art. Suitable applications include various heat-sink applications such as electronics, printed electronics, and housings or in automotive parts, including invertors, On Board Chargers (OBCs), and Power Distribution Units (PDUs).

Having described the invention in detail, it will be apparent that modifications and variations are possible without departing from the scope of the invention defined in the appended claims.

When introducing elements of the present invention or the preferred embodiments(s) thereof, the articles “a”, “an”, “the” and “said” are intended to mean that there are one or more of the elements. The terms “comprising”, “including” and “having” are intended to be inclusive and mean that there may be additional elements other than the listed elements.

In view of the above, it will be seen that the several objects of the invention are achieved and other advantageous results attained.

As various changes could be made in the above compositions and processes without departing from the scope of the invention, it is intended that all matter contained in the above description shall be interpreted as illustrative and not in a limiting sense.

1. A process of forming an article, the process comprising:
providing a thermally conductive polymer, wherein the polymer comprises spherical nano-particles and is in the form of a filament; and
extruding the filament in a fused filament formation process to produce a 3D printed article comprising the thermally conductive polymer.

2. The process of claim 1, wherein the thermally conductive polymer has a cold crystallization temperature of less than about 220° C.

3. The process of claim 1, wherein the thermally conductive polymer has a crystallinity of less than about 5%.

4. The process of claim 1, wherein the thermally conductive polymer has a viscosity of less than about 1.0E+3 at 290° C. and 1 S⁻¹ shear rate.

5. The process of claim 1, wherein the filament is extruded in layers.

6. The process of claim 1, wherein the spherical nano-particles include at least one of nano-diamonds, fumed silica, nano-alumina, fumed alumina, or combinations thereof.

7. The process of claim 1, wherein the spherical nano-particles are present in the thermally conductive polymer at a concentration of from about 0.1 wt. % to about 2 wt. %.

8. The process of claim 1, wherein the thermally conductive polymer comprises a polymer matrix comprising at least one polymer selected from the group consisting of polyphenylene sulfide, polyamide, polyketone, polyolefin, and mixtures thereof.

9. The process of claim 8, wherein the thermally conductive polymer comprises a thermally conductive filler in the polymer matrix.

10. The process of claim 9, wherein the thermally conductive filler comprises at least one of boron nitride, carbon fiber, graphite, carbon nanotubes, or mixtures thereof.

11. A process of forming an article, the process comprising:
providing a thermally conductive polymer, wherein the polymer is in the form of a filament and has a viscosity of less than about 1.0E+3 at 290° C. and 1 S⁻¹ shear rate; and
extruding the filament in a fused filament formation process to produce a 3D printed article comprising the thermally conductive polymer.

12. The process of claim 11, wherein the filament is extruded in layers.

13. The process of claim 11, wherein the thermally conductive polymer comprises spherical nano-particles.

14. The process of claim 13, wherein the spherical nano-particles include at least one of nano-diamonds, fumed silica, nano-alumina, fumed alumina, or combinations thereof.

15. The process of claim 13, wherein the spherical nano-particles are present in the thermally conductive polymer at a concentration of from about 0.1 wt. % to about 2 wt. %.

16. The process of claim 11, wherein the thermally conductive polymer comprises a polymer matrix comprising at least one polymer selected from the group consisting of polyphenylene sulfide, polyamide, polyketone, polyolefin, and mixtures thereof.

17. The process of claim 16, wherein the thermally conductive polymer comprises a thermally conductive filler in the polymer matrix.

18. The process of claim 17, wherein the thermally conductive filler comprises at least one of boron nitride, carbon fiber, graphite, carbon nanotubes, or mixtures thereof.

19. A thermally conductive polymer comprising:
a polymer matrix; and
spherical nano-particles in the polymer matrix;
wherein the thermally conductive polymer has a viscosity of less than about 1.0E+3 at 290° C. and 1 S⁻¹ shear rate configuring the polymer to have adequate layer adhesion and sufficient surface quality such that the polymer is suitable for fused filament fabrication.

20. The polymer of claim 19, further comprising a thermally conductive filler in the polymer matrix.
